(19) United States
(12) Patent Application Publication
(10) Pub. No.: US 2004/0039684 A1
(43) Pub. Date: Feb. 26, 2004

(54) Emission reduction trading system and method

(76) Inventor: Richard L. Sandor, Chicago, IL (US)

Correspondence Address: FOLEY & LARDNER, 150 EAST GILMAN STREET, P.O. BOX 1497, MADISON, WI, 53701-1497, US

(21) Appl. No.: 10/623,134

(22) Filed: Jul. 18, 2003

Related U.S. Application Data
(60) Provisional application No. 60/397,401, filed on Jul. 20, 2002.

(51) Int. Cl. G06F 17/60

(52) U.S. Cl. 705/37

(57) ABSTRACT

An emission reduction trading system and method can include a registry that stores emission allowance and offset holding information for participants in a greenhouse gas emissions market and a trading platform communicatively coupled to the registry and enabling trades of emission allowances and offsets by participants. The method of conducting trades among participants includes establishing baselines and reduction levels, obtaining emissions information including emissions allowance and offset information, determining on an individual participant basis required purchases and allowed sales, and managing trades among participants to meet the determined required purchases and allowed sales.

### FIELD OF THE INVENTION

The present invention relates generally to trading systems and methods. More particularly, the present invention relates to an emission reduction trading system and method.

### BACKGROUND OF THE INVENTION

The world's environment faces significant threats from anthropogenic or “human-caused” releases of greenhouse gases to the atmosphere. Greenhouse gases, such as water vapor, carbon dioxide, tropospheric ozone, nitrous oxide, and methane, are generally transparent to solar radiation but opaque to longwave radiation, thus preventing longwave radiation energy from leaving the atmosphere. The net effect of greenhouse gases in the atmosphere is a trapping of absorbed radiation and a tendency to warm the planet's surface.

Greenhouse gases can be released, for example, by the release of carbon dioxide during fossil fuel combustion. Thus, automobiles, factories, and other devices that combust fuel release carbon dioxide gases into the atmosphere. However, greenhouse gases can also be released by more natural means. For example, farmers may till farmland such that carbon dioxide from the tilled ground is released into the air. The removal of forest stands, or deforestation, can also result in the release of greenhouse gases.

In general, the rapid increases in the concentration of greenhouse gases in the earth's atmosphere caused by human activity increases the risk of fundamental and costly changes in the earth's climate system. Such risks can include more severe drought/precipitation cycles; longer and more extreme heat waves; spread of tropical diseases; damage to vegetation and agricultural systems; and threats to coastlines and property due to higher sea levels and storm surges.

In the 1980's, the United States implemented an emissions trading system to phase out lead from motor fuel. This effort was followed by a highly successful U.S. Environmental Protection Agency (EPA) sulfur dioxide (SO₂) emissions trading program. To reduce acid rain, an overall cap on SO₂ emissions was imposed on electric power plants. Utilities that found it expensive to cut sulfur emissions could buy allowances from utilities that make extraordinary cuts at low cost.

The SO₂ program has been successful. Emissions were reduced faster than required and costs were far below most forecasts. There has also been steady growth in the trading of allowances, from 700,000 tons in 1995 to approximately 12 million tons in 2001. The SO₂ emissions market has now reached a value of approximately $2 billion each year for registered trades.

The environmental and economic success of the U.S. sulfur dioxide allowance trading program to reduce acid rain, as well as other similar markets, provides evidence of the benefits of emissions trading on a large-scale. Emissions trading introduces scarcity by establishing limits on overall emissions, specifying firm-level limits, and allowing those who can cut emissions at low cost to make extra cuts. Companies facing high costs to cut emissions can comply by purchasing tradable emission rights from those who make extra cuts. The market in a property-like instrument—emission allowances—helps assure efficient use of the limited resource (the environment) and yields a price that signals the value society places on use of the environment. That price represents the financial reward paid to those who reduce emissions, and also indicates the value of creating innovative pollution reduction techniques.

Emission allowance trading systems, sometimes referred to as “cap and trade” systems, can be supplemented by project-based “Offsets” that reflect reduction of greenhouse gases and/or capture and storage of carbon dioxide. Offsets can be generated by individual initiatives undertaken by entities that are either not significant emission sources, or have emission profiles that are naturally incorporated into the market as Offsets. For example, individual farmers can absorb and store carbon dioxide in soils by maintaining cropping practices that use conservation tillage. Conservation tillage involves minimal disturbance of the soil, thus trapping carbon that was transmitted to the soil by growth of plants. Incorporation of Offsets provides industrial emission sources with an additional source of greenhouse gas mitigation, while also providing a funding source for activities, such as conservation tillage, which produce local environmental benefits such as improved water quality.

Many major industrial nations have sought the design of a greenhouse gas emissions trading program that can provide corporations and others an organized, market-based mechanism for cost-effectively reducing global warming gases. This endeavor presents a means for effectively addressing climate change while offering its owners and members a significant commercial opportunity.

While national and sub-national governments have been studying greenhouse gas emissions trading programs, for several years private sector leaders in many countries have financed mitigation projects and conducted trading with informal “carbon credits.” A World Bank study reports that this nascent over-the-counter market has included several dozen significant trades. The study found that, in the absence of any regulatory framework, the dollar volume of over-the-counter transactions has already surpassed $200 million. Furthermore, The Economist magazine projects an annual volume of trading ranging from $60 billion to $1 trillion.

Numerous governments have moved beyond planning and are implementing formal greenhouse gas markets, including the U.K., Denmark, and the Netherlands, as well as Massachusetts and New Hampshire. The European Union has established the framework for a carbon dioxide emissions trading system to be employed starting 2005. The European Union Directive establishes an initial phase market in advance of a broader and more comprehensive greenhouse gas emissions trading system among energy and industrial facilities in its member states starting in 2008.

A number of states, provinces, exchanges and multilateral institutions have made detailed preparations for trading. It is in this context, recognition of a serious environmental risk, desire for least-cost responses, increasing regulation worldwide, and demands from stakeholders that the present invention offers solutions to challenges in establishing and operating a greenhouse gas trading exchange.

Examples of barriers to greenhouse gas trading include regulatory uncertainty; lack of a clear, widely-accepted definition of the commodity; lack of standards for monitoring, verification, and trade documentation; lack of standards for eligibility of project-based emission offsets; and lack of organized markets and clear market prices. Other barriers and challenges also exist. These barriers constitute significant transaction costs that impede progress in adoption of greenhouse gas reduction commitments by raising the costs of achieving such commitments.

Thus, there is a need for an improved emissions reduction trading system that allows realization of greenhouse gas reduction objectives at lower transaction costs. Further, there is a need for an organized trading system to promote the reduction of greenhouse gas emissions. Even further, there is a need for a standards-based, organized trading market for greenhouse gases.

### SUMMARY OF THE INVENTION

The present invention relates to the systems and methods associated with the creation, maintenance, and operation of a greenhouse gas emissions trading market. These systems and methods minimize the transaction costs of executing trades that allow system-wide reductions in the cost of achieving reductions in greenhouse gas emissions. This trading market takes advantage of a collective desire of many companies to reduce greenhouse gas emissions. The trading market is preferably rules-based, self-governing and operational by member commitments without direct involvement of government entities.

At least one exemplary embodiment of the present invention is related to an emission reduction trading system that includes a registry to store emission allowance and offset holdings information for participants in a greenhouse gas emissions market and a trading platform communicatively coupled to the registry and enabling trades of emission allowances and offsets by participants.

Another exemplary embodiment is related to a method of conducting trades among participants in an emissions reduction trading system over a communication network. The method includes establishing baselines for participants in an emissions trading market and reduction levels from the baselines, obtaining emissions information from the participants; maintaining a record of holdings of emission allowances and emission offsets; a means for trading emission allowances and offsets; determining on an individual participant basis required purchases and allowed sales, and managing trades among participants to meet the determined required purchases and allowed sales.

Yet another exemplary embodiment is related to a system for conducting trades among participants in an emissions reduction trading system over a communication network. The system includes means for establishing baselines for participants in an emissions trading market and reduction levels from the baselines; means for obtaining emissions information from the participants; maintaining a record of holdings of emission allowances and offsets; a means for trading emission allowances and offsets; means for determining on an individual participant basis required purchases and allowed sales; and means for managing trades among participants to meet the determined required purchases and allowed sales.

Another exemplary embodiment relates to a method of employing standards in the creation, maintenance, and operation of a greenhouse gas emissions trading market. The method includes establishing and operating a greenhouse gas emissions trading market using standards for: trading Carbon Financial Instruments, measurement of emissions and reductions, reporting of emissions and mitigation projects, eligible offset projects, the emissions reductions, constraints on trading, an annual true-up procedure, mitigation programs, and maximum required purchases and maximum allowed sales. The trade Carbon Financial Instruments include any one of allowances and offsets. In addition, another instrument can be early action credits. The emission reductions include baseline emission information and types of included facilities. The constraints include single-firm sales limits.

Another exemplary embodiment relates to an electricity opt-in method in an emissions reduction trading system. The method includes establishing an electricity purchase baseline for a market participant, receiving information on electricity purchases for the market participant, determining qualification for allowance surplus or shortfalls based on the received information on electricity purchases for the market participant, and transacting the allowance surplus or shortfalls as determined.

Another exemplary embodiment relates to an emissions reduction trading system including an electricity opt-in program. The system includes means for establishing an electricity purchase baseline for a market participant, means for receiving information on electricity purchases for the market participant, means for determining qualification for allowance surplus or shortfalls based on the received information on electricity purchases for the market participant, and means for transacting the allowance surplus or shortfalls.

Another exemplary embodiment relates to an auction, which can be conducted over a network of computers. The auction is for the purchase and selling of greenhouse gas allowances in an emissions reduction and trading system. The auction includes an auction pool of greenhouse gas allowances received from an auction reserve or allowance offers, which can include a mechanism for electronically-received, manually-received bids, or a live auction of greenhouse gas allowances in the auction pool, and a processor to determine winning bids based on pre-determined parameters. The processor is configured to communicate auction results to member accounts in a registry for transfer of allowances. The processor is further configured to return proceeds pro rata to participants based on contributions of the participants to the auction reserve.

Other principle features and advantages of the invention will become apparent to those skilled in the art upon review of the following drawings, the detailed description, and the appended claims.

### BRIEF DESCRIPTION OF THE DRAWINGS

The exemplary embodiments will hereafter be described with reference to the accompanying drawings.

FIG. 1 is a block diagram of an emissions reduction trading system in accordance with an exemplary embodiment of the present invention.

FIG. 2 is a diagrammatic representation of auction functionality within the system of FIG. 1 in accordance with an exemplary embodiment.

FIG. 3 is a block diagram of an emissions reduction and trading system in accordance with another exemplary embodiment.

FIG. 4 is a flow diagram depicting exemplary operations performed in the creation of baselines and allowance allocations.

FIG. 5 is a graph of an exemplary emissions baseline, reduction schedule, economic growth provision, and maximum mitigation quantities.

FIG. 6 is a graph of an exemplary growth provision, maximum required purchases, and allowed sales quantities.

FIG. 7 is a diagrammatic representation of mutli-sector emissions monitoring, reporting, and auditing for emissions baselines and periodic emissions reports.

FIG. 8 is a diagrammatic representation of an exemplary true-up process.

FIG. 9 is a diagrammatic representation of exemplary offset project registration and reporting.

FIG. 10 is a diagrammatic representation of an exemplary crediting mechanism for methane combustion.

FIG. 11 is a graph of exemplary forestry offsets based on carbon storage.

FIG. 12 is an exemplary map of agricultural soil offsets based on geographic region.

FIG. 13 is a diagrammatic representation of an exemplary issuance of greenhouse gas emission allowances upon increases in qualifying carbon stocks.

FIG. 14 is a diagrammatic representation of an exemplary offset verification process.

### DETAILED DESCRIPTION OF EXEMPLARY EMBODIMENTS

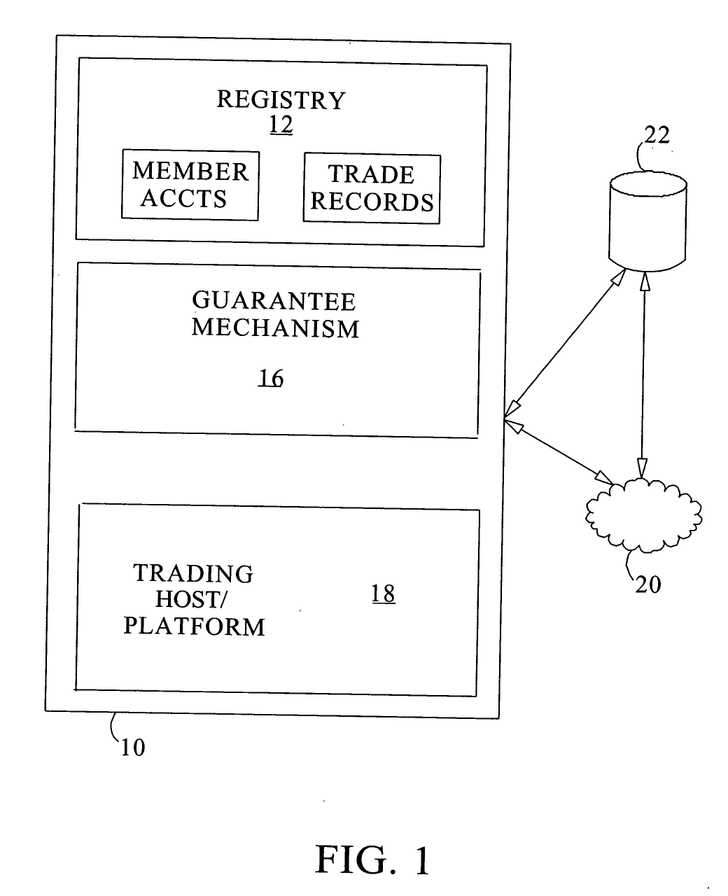

Turning now to the FIGURES that illustrate exemplary embodiments of the invention, FIG. 1 illustrates a diagrammatic representation of an emissions reduction and trading system 10. The system 10 can include a registry 12, a guarantee mechanism 16, and a trading host or platform 18. The system 10 can be coupled to a network 20, such as the Internet or any other public or private connections of computing devices. The system 10 can be communicatively coupled to an emissions database 22 either directly or via the network 20.

The registry 12 serves as the official record of emission allowance and offset holdings of each participant in the commodity market managed by the system 10. Trades become officially acknowledged for compliance purposes only when they are transferred across accounts in the registry 12. The holdings of the registry 12 can be Carbon Financial Instruments, such as, exchange allowances (XAs), exchange emission offsets (XOs) generated by mitigation projects, and exchange early action credits (XEs). Each instrument represents one hundred metric tons of CO₂ and is preferably designated with a specific annual vintage. Each instrument is recognized as equivalent when surrendered for compliance (subject to certain constraints described below). Carbon Financial Instruments may be used in compliance in their designated vintage year or in later years.

In an exemplary embodiment, the registry 12 is designed to have secure Internet access by participants to their own accounts. The registry 12 may be configured to provide access of accounts by the public, but this access would be on a view-only basis. Preferably, the registry 12 is configured with the ability to interface with registries in other greenhouse gas markets. The registry 12 is linked to the trading platform 18 and financial guarantee mechanism 16. The combination of these three components provides a clearinghouse system.

The guarantee mechanism 16 enhances market performance in several ways. The guarantee mechanism 16 ensures that those who conduct sales of Carbon Financial Instruments on the trading platform 18 receive next-day payment even if the buyer fails to execute the payment process. This mechanism allows for anonymous trading by eliminating the need to address the credit worthiness of buyers. Non-payment risk is eliminated, thus removing a transaction cost. This feature allows the participation in trading by liquidity providers (including “market makers”), who can stand ready to promptly buy and sell. The presence of standing buyers and sellers increases trading activity, which improves the economic efficiency of the price discovery process. In addition, the ability to trade anonymously allows members to post bids and offers and execute trades without revealing their trading strategies. The guarantee mechanism 16, eliminates the risk that a buyer may fail to make payment.

Upon enrollment as an exchange member, the member is allocated a time stream of original issue allowances that are designated with yearly vintages. Regardless of the method of trading employed, all deliveries of exchange allowances (XAs) and exchange offsets (XOs) occur by having the transferor instruct the registry 12 to move allowances of offsets from its account to the account of the transferee. Subsequent to year-end, the emission source must transfer a quantity of appropriate vintage allowances or offsets equal to its total emissions during the prior year to the retirement account. Subsequent to the end of a compliance year, each exchange member must designate for retirement a quantity of tradable exchange Carbon Financial Instruments equal to total emissions of that participant during the compliance year.

The trading platform 18 is an electronic mechanism for hosting market trading. The trading platform 18 provides participants with a central location that facilitates trading, and publicly reveals price information. The trading platform 18 reduces the cost of locating trading counter parties and finalizing trades, an important benefit in a new market. The trading platform 18 may also be used as the platform for conducting the periodic auctions.

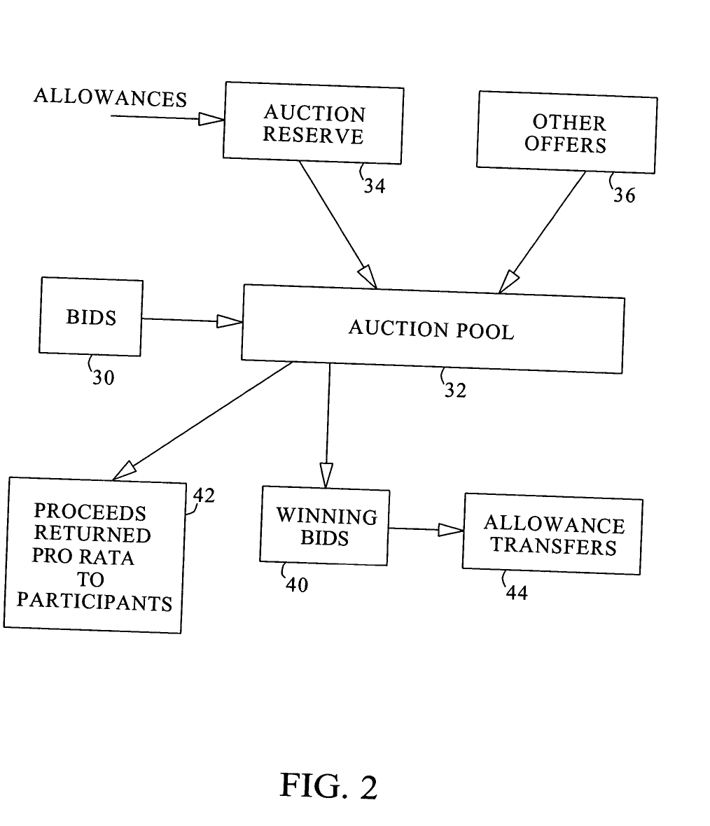

FIG. 2 illustrates an exemplary annual auction performed using system 10 described with reference to FIG. 1. Alternatively, the auction can be held intermittently throughout a year. In an exemplary embodiment, the auction operates by providing bids 30 and offers for allowances to an auction pool 32. The auction pool 32 can receive allowances from an auction reserve 34 and other offers 36. The auction reserve 34 includes exchange allowances (e.g., the XAs). Auction results include public price information 38, winning bids 40, and proceeds returned pro rata to participants 42. Winning bids 40 result in allowance transfers 44 between accounts in the registry 12 described with reference to FIG. 1.

Advantageously, auctions of greenhouse gas emission allowances provide an orderly mechanism for assisting the market. By publicly revealing prices, the auctions provide critical information to participants. Prices help participants formulate reasonable private trading terms and, importantly, provide signals indicating which internal greenhouse gas mitigation actions are economically logical and which actions are best performed by other participants who face lower mitigation costs.

The system 10 preferably conducts periodic auctions of exchange allowances (XAs) (possibly including exchange emission offsets (XOs) for the purpose of revealing market prices, encouraging trade, and expanding market participation. In an exemplary embodiment, a single-clearing price auction is performed. Alternatively, a discriminating price auction is used. A discriminating price method is used in the Chicago Board of Trade auctions for sulfur dioxide emission allowances. By way of example, a single clearing price auction is understood to be an auction where all buyers pay the lowest price of all accepted bids. In contrast, a discriminating price auction is understood to be an auction where the successful buyers pay the price they bid regardless of what other accepted bid prices are. As such, it is possible to have different accepted prices in the same auction.

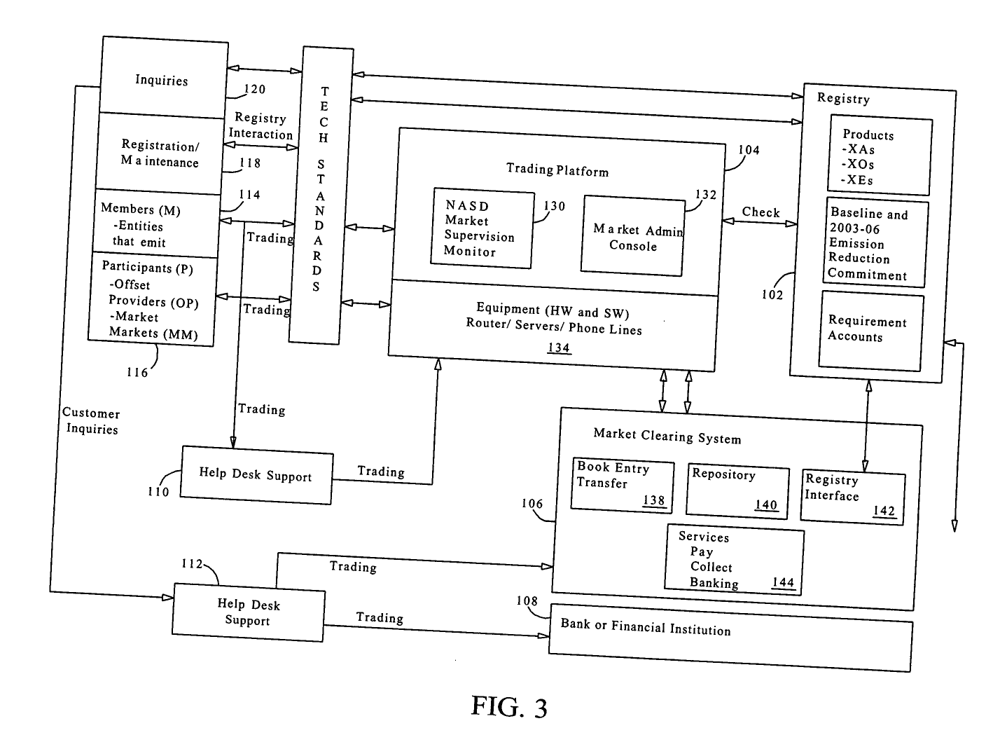

FIG. 3 illustrates an emissions reduction and trading system 100. The system 100 can include a registry 102, a trading platform 104, a clearing component 106, a financial institution 108, a help desk 110, and a help desk support component 112. In general, members 114 and/or participants 116 interact with the trading platform 104 to engage in buying and selling allowances and offsets. For registration/maintenance 118 and general inquiries 120, the members 114 and/or participants 116 interact directly with the registry 102. In either case, communication is done by way of technology standards 122. The technology standards 122 can include internet protocol standards and other technology-specific standards that facilitate communication by members 114 and/or participants 116.

The registry 102 can include information regarding system products, such as, XAs, XOs, and XEs, as well as information regarding baseline and emission reduction commitments. The registry 102 can be implemented using a database and computer software. The registry 102 can also include information on retirement accounts for allowances and offsets and early action credits based on activities prior to establishment of the system.

The trading platform 104 provides members 114 and participants 116 with a structure that enables the trading of emission allowances and offsets. The trading platform 104 can be implemented as a software program providing a user interface that enables the execution of various functions. The trading platform 104 can include a market supervision monitor 130, a market administration console 132, and equipment 134. The equipment 134 can include hardware and/or software, such as, routers, servers, phone lines, and the like. The market administration console 132 allows the exchange to manage, intervene, and controls accounts and make adjustments to accounts (e.g., where member sells an emission source). The market supervision monitor 130 facilitates the oversight of trading done using the trading platform 104 for adherence to system rules.

The trading platform 104 is coupled to the registry 102 to obtain and communicate information, such as, account information and trading records. The trading platform 104 also interacts with the clearing component 106 in the carrying out of trades performed by members 114 and participants 116 on the trading platform 104. The clearing component 106 can include a book entry transfer 138 that constitutes the official mechanism by which delivery of tradable Carbon Financial Instruments occurs, a repository 140, a registry interface 142, and a collection component 144. The financial institution 108 provide for settlement of trades and may provide a mechanism by which financial performance is guaranteed.

The help desk 110 provides trading support for members 114 and participants 116 for trades using the trading platform 104. The help desk support component 112 assists in customer inquiries that are made directly to the system without going through the trading platform 104, which may be provided and maintained by a third party.

The market (as embodied in system 10 or system 10) has been designed with a view to commoditizing Carbon Financial Instruments used in the trading of Carbon Financial Instruments instruments. Uniform and fully fungible Carbon Financial Instruments (e.g., exchange allowances, exchange offsets, and exchange early action credits) allow for easy transfer and flexibility among participants. Uniformity reduces transaction costs, increases predictability and enhances market liquidity. Such features are a few of the improvements relative to the heterogeneous and high transaction costs associated with practices currently used in the informal market for greenhouse gas emission reductions.

Each member of the market managed by the system 10 (described with reference to FIG. 1) or the system 100 (described with reference to FIG. 3) (hereinafter collectively referred to as the “market”) has an emission baseline, which can be the average of its emissions during certain previous years such as 1998 through 2001.

An emissions baseline preferably reflects a detailed assessment of patterns of industrial activity and practical considerations, such as data availability. Emissions baselines can be adjusted to reflect acquisition or disposition of facilities. A reference emission level is preferably established to be able to obtain emissions data, reflect variations in economic cycles, and perform operations. An emission reduction schedule can be defined from the reference emission level.

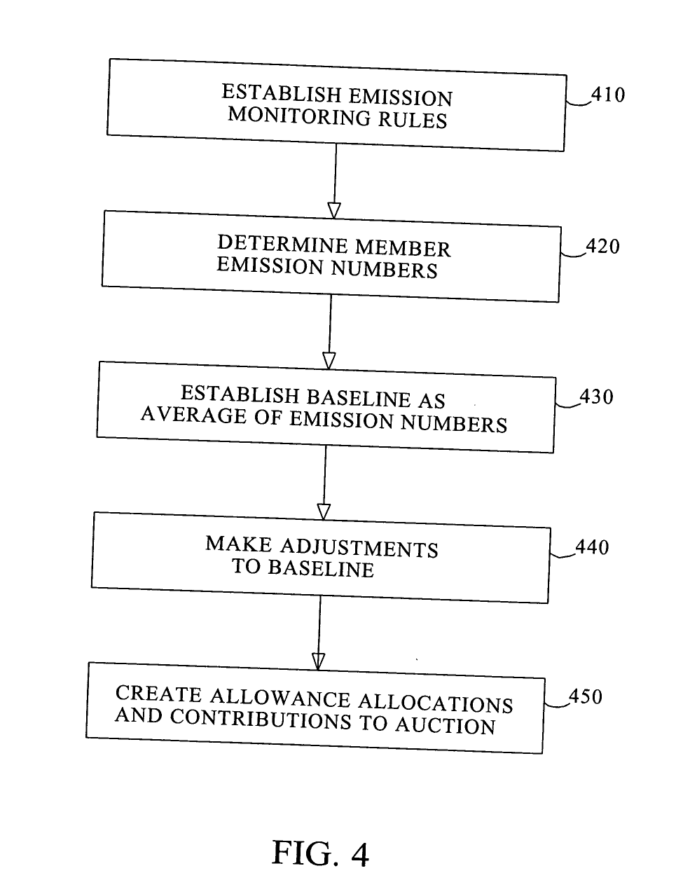

FIG. 4 illustrates operations performed in the creation of baselines and allowance allocations in the market. Additional, fewer, or different operations may be performed, depending on the embodiment. In an exemplary embodiment, an operation 410 is performed in which emission monitoring rules are established. Emission monitoring rules can relate to included facilities, included gases, and/or excluded gases. These rules designate what activities count toward emissions.

In an operation 420, member emission numbers are determined using the emission monitoring rules. Emission numbers can be submitted to the market by members or obtained electronically over a network from a database. Emission monitoring rules are applied such that the member emission numbers are accurate for the creation of a baseline. Preferably, the definition of the baseline includes rules governing inclusion of facilities and specifications for defining emissions “ownership” at jointly-owned facilities, and rules for addressing gaps in the baseline period emissions data. Once the emission numbers are obtained, member baselines are established in an operation 430. The baseline can be an average of emission numbers over a certain time period, such as four years.

Adjustments can be made to the baseline in an operation 440. Baseline adjustments can be upward, for example, when emitting facilities are acquired by the member. Similarly, baseline adjustments can be downward, for example, when a member disposes of an emitting facility.

Having established a baseline, an operation 450 can be performed to create allowance allocations and contributions to the auction. An emission reduction schedule created by the market is applied to create an emission schedule for each member. Preferably, the emission reduction schedule utilizes a known rule that is common among all participants. By way of example, the schedule can call for reductions of 1%, 2%, 3% and 4% below baseline emission levels during, e.g., years 2003, 2004, 2005 and 2006 respectively. Members annually surrender a quantity of Carbon Financial Instruments (e.g., exchange allowances, exchange emission offsets, when applicable, exchange early action credits) equal to their yearly emissions. Those members that reduce emissions below these levels can sell or bank their excess Carbon Financial Instruments, while those with emissions above the reduction schedule must purachase Carbon Financial Instruments in order to achieve compliance.

Advantageously, the emission reduction schedule is uniform and easily understood. Its simplicity facilitates participation by a diverse range of businesses and other entities, thus increasing both the environmental effectiveness of the program and the potential for enrollment of entities that are able to reduce emissions at low-cost. As shown in Table 1 below, the emission reduction objective declines 1% per year, and the cumulative four-year emission reduction relative baseline emission levels is 10% (1%+2%+3%+4%). This simple value facilitates easy analysis of potential implications of participation as well as planning efforts.

TABLE 1

| | Market Emission Reduction |
|---|---|
| | Schedule, Exchange |
| Year | Allowance Allocations |
| 2003 | 1% below participant's baseline |
| 2004 | 2% below participant's baseline |
| 2005 | 3% below participant's baseline |
| 2006 | 4% below participant's baseline |

Each member is preferably allocated a four-year stream of emission allowances. The registry 12 (or the registry 102 in the case of the system 100 of FIG. 3) employs a system that identifies the vintage of each instrument. The market monitors instrument transfers and holdings and facilitates the oversight needed to enforce rules, such as the restrictions on banking and the single-firm sales limit.

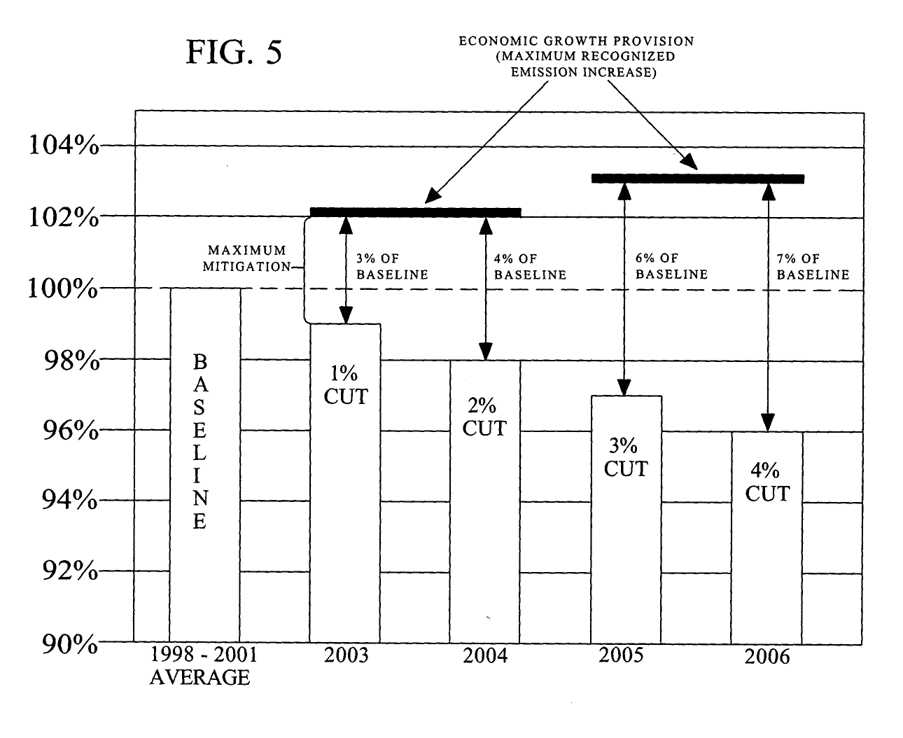

FIG. 5 illustrates a graph of an exemplary emission baseline, reduction schedule, economic growth provision, and maximum mitigation quantities. The graph includes a dotted line horizontally across from 100% to designate an emission baseline for a particular member. Each year going forward, emission targets are reduced by a reduction schedule. The graph depicts a yearly reduction schedule of 1% per year.

The graph of FIG. 5 also indicates that the maximum quantity of emission mitigation required rises at a fixed rate over time. In an exemplary embodiment, the market is configured such that the maximum amount of CO₂ equivalent emissions recognized in determining the annual true-up for each member is 2% above that participant's baseline emission level during year 1 and year 2, and 3% above baseline during year 3 and year 4. As such, there is an established limitation on the risk exposure faced by pilot market participants. Without such a provision, the maximum potential quantity of purchases of Carbon Financial Instruments that each member may face would be unknown. This mechanism allows potential participants to know, in advance with certainty, the maximum quantity of purchases they may have to undertake to achieve compliance with the annual emission reduction commitments. This provision is referred to as the economic growth provision.

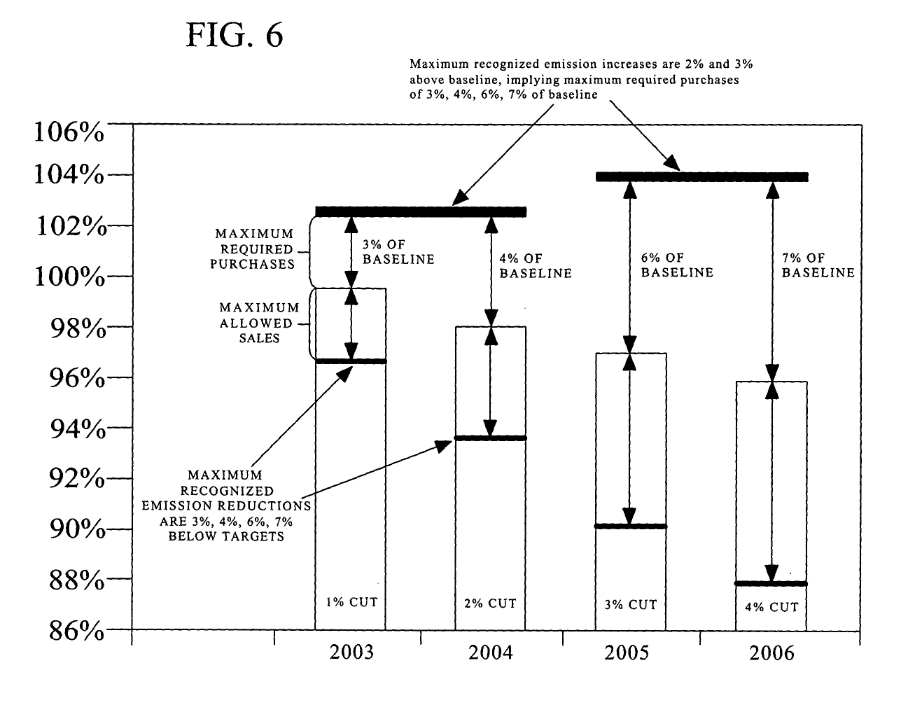

FIG. 6 illustrates a graph of an exemplary economic growth provision, maximum required purchases, and allowed sales quantities described with respect to FIG. 5. For each instrument vintage, there is a maximum number of emission allowances that can be sold as well as a maximum number of emission allowances that must be bought. These restrictions reflect the symmetric application of the economic growth provision.

Emissions levels can be unpredictable and are often influenced by factors external to a business (e.g., weather, economic conditions, plant outages). The economic growth provision provides a measure of insulation against such uncertainties. This risk-reducing feature allows potential members to establish better-informed estimates of the highest possible financial exposure associated with participation. This increased predictability is expected to result in greater participation in the voluntary market, thus yielding more environmental progress and helping to advance market infrastructure while developing human capital in GHG emissions trading. The benefits of this provision are particularly important for entities facing rapid emissions growth (e.g., due to population growth in their customer base). Development of tools for initiating GHG mitigation efforts in countries with rapid emissions growth, such as China and India, is recognized as one of the world's significant challenges in the long-term global effort to effectively counter the threats of global climate change.

At the same time, there is a limit applied to participants in the market to allowed sales. In an exemplary embodiment, maximum recognized emission reductions mirror the maximum required purchases. For example, sales are limited to 6% of baseline where required purchases are limited to 6%.

Certain individual members may be in a position to sell large quantities of exchange allowances. Should any single member or small group of members be allowed to sell without limit, the market could become imbalanced and subject to price congestion. Similarly, unrestrained ability to sell could cause a single-firm to achieve a dominant status of the sell-side of the market, which would be damaging to market competition. Thus, the quantity of sales any single firm can make is constrained to avoid market imbalance, price congestion and potential for market dominance by a single seller or a small group of sellers of exchange allowances. This provision is applied to all members that have baseline emissions in excess of 100,000 metric tons CO₂ equivalent. This exception reflects the fact that unrestricted sales by small members would not cause undesirable market impacts, and that removal of such constraint increases the likelihood that the fixed costs of market membership can be more than offset from proceeds from sales of Carbon Financial Instruments.

Net allowed sales by a single firm are preferably escalated if program-wide emissions rise above baseline levels. The escalation mechanism reflects the extent to which program-wide emissions rise above program-wide baseline emission levels. For a particular vintage, each member is allowed to sell and/or bank the quantity of allowances that is the lesser of the quantities determined by the symmetric economic growth provision and the single firm sales limit. (In this context, allowed sales means the net sales by the member.) If for the first vintage year, the single firm sales limit is less than the quantity determined by the symmetric economic growth provision, then the difference between those two quantities is placed in a special reserve for possible future release.

For subsequent vintages, each member is allowed to sell and/or bank the quantity that is the lesser of the quantities determined by the economic growth provision and the single firm sales limit. For these vintages, members may also bank the amount by which the quantity determined by the economic growth provision exceeds the single firm sales limit.

As such, market imbalance and price congestion that might arise if members are allowed to carry forward large amounts of surplus exchange allowances that may arise due to economic recession or other factors are avoided.

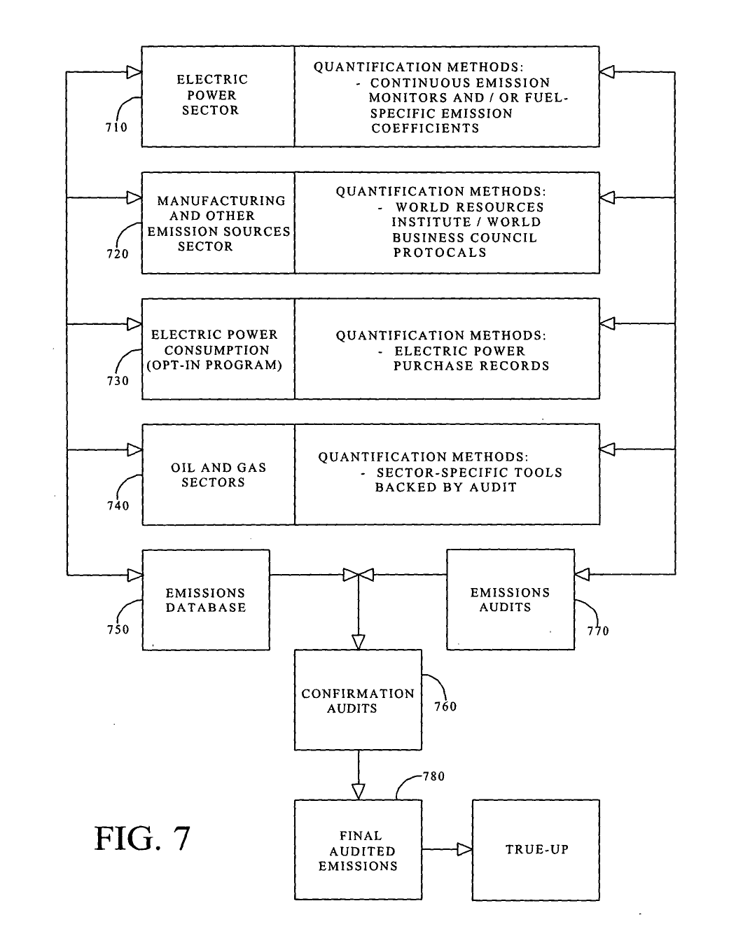

FIG. 7 illustrates the market as applied to multi-sector emissions monitoring, reporting, and auditing for emissions baselines and periodic emissions reports. Any of a number of market sectors, such as an electric power sector 710, a manufacturing sector 720, an electric power consumption sector 730, and an oil and gas sector 740, can report information to an emissions database 750 in the system 10 or the system 100. For example, the electric power sector 710 can use a quantification method of continuous emission monitors and/or fuel specific emission coefficients. The electric power sector 710 can also perform coal testing for carbon content. Emissions information obtained using these types of quantification methods is communicated to the emissions database 750.

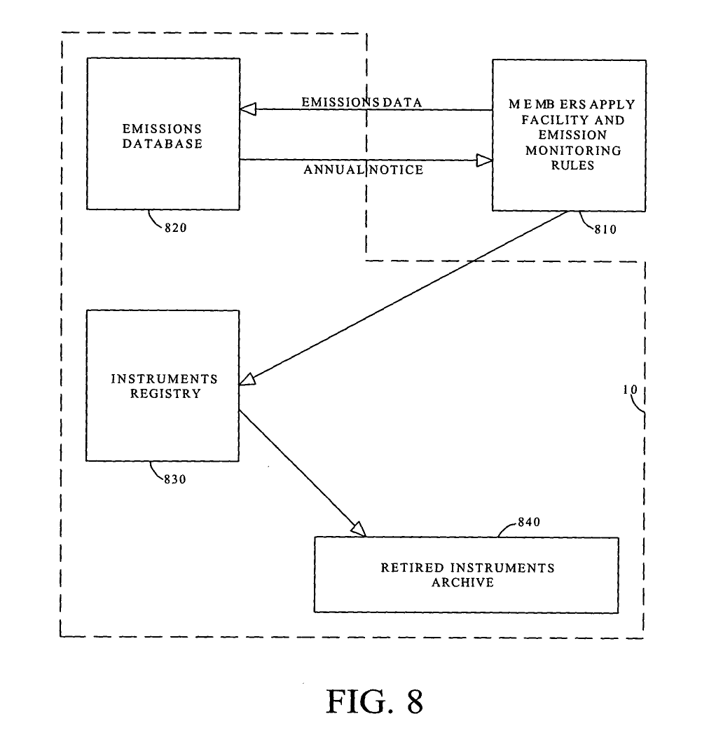

The information received from sectors 710-740 by emissions database 750 can be used by the market to make confirmations and adjustments to Carbon Financial Instruments in an operation 760. NASD emissions audits 770 can be used in the operation 760 to make these confirmations and adjustments. Final audited emissions 780 can be used in a true up process described below with reference to FIG. 8.

Additional, fewer, or different sectors may be included in the market besides or in place of sectors 710-740. In an exemplary embodiment, members primarily engaged in electric power production include in their baseline and quarterly emission reports CO₂ emissions from all power generation facilities having a rated capacity of 25 megawatts or larger. These members may opt-in emissions from facilities having rated capacity less than 25 megawatts, but must include all such facilities if this option is chosen. Electric power generating units use CO₂ emissions data from continuous emission monitors (CEMs) as reported to the U.S. Environmental Protection Agency. In other cases where CEM data is not available, such members quantify CO₂ emissions by using the fuel consumption methods contained in government regulations.

These provisions represent adoption of specified rules for CO₂ emissions monitoring and facilities inclusion for participation by entities primarily engaged in electric power generation in an organized GHG reduction and trading program. Advantageously, this provides a multi-sector GHG trading program for electric power generating plants.

Market electric power sector members may also opt-in SF₆ emissions from electric power transmission equipment. Emissions from such systems can be quantified using protocols provided by the U.S. Environmental Protection Agency. These members may also opt-in emissions from vehicles they own and operate or lease by using the protocols developed by the World Resources Institute/World Business Council for Sustainable Development (WRI/WBCSD) initiative. These provisions represent adoption of specified rules for SF 6 emissions monitoring and facilities inclusion for participation by entities primarily engaged in electric power generation in an organized GHG reduction and trading program.

Other members, including members in the forest products, chemicals, cement, manufacturing, and municipal sectors can report greenhouse gas emissions as follows. CO₂ emissions from stationary source fossil fuel combustion can be quantified using the protocols developed by the WRI/WBCSD. Process emissions (e.g., N₂O, PFCs and CO₂) can be quantified using applicable WRI/WBCSD protocols. CO₂ emissions from vehicles can be included in the member's baseline and quarterly emission reports if these emissions are greater than 5% of total entity-wide emissions and represent an integral part of the member's operations. Otherwise, members have the option to include emissions from vehicles in their baseline emissions and quarterly emission reports. Vehicle emissions can be quantified using the WRI/WBCSD protocols.

Member sources not primarily engaged in the production of electricity may opt-in purchased electricity (sector 730 in FIG. 7) as a supplemental reduction objective. When this option is elected, reduction commitments for purchased electricity are identical to the market emission reduction schedule (e.g., 1% below baseline in 2003, 2% below baseline in 2004, 3% below baseline in 2005, 4% below baseline in 2006). Members that elect this option receive greenhouse gas emission allowances when the reduction objective is exceeded. When members opt-in their electricity purchases and their electricity purchase reduction objective is not achieved, the member must surrender greenhouse gas emission allowances and/or CEOs.

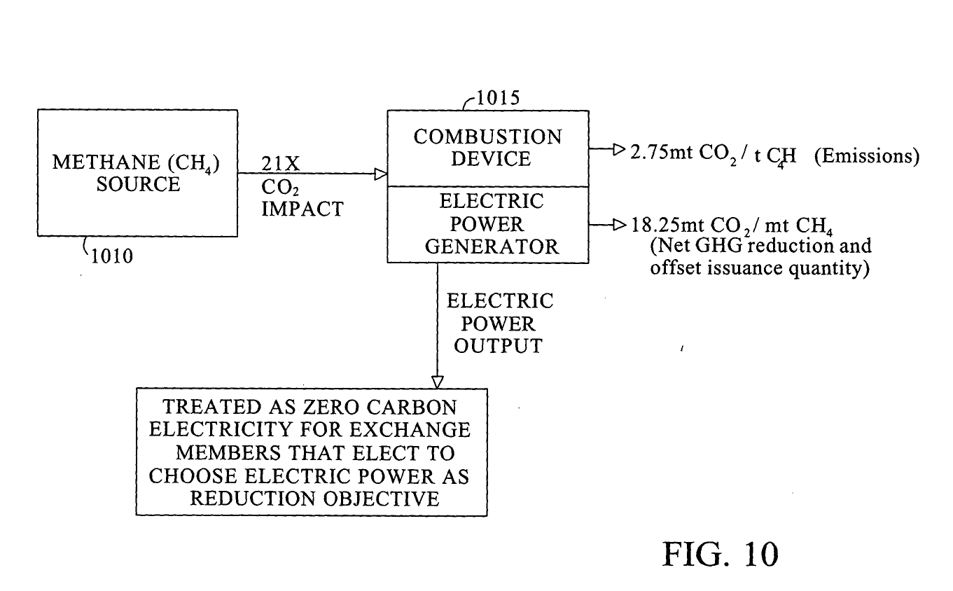

Entities can contribute to mitigation of greenhouse gases by reducing electricity purchases (e.g., through improved “end use” efficiency). Such entities are credited when the reduction objectives are exceeded, or are held responsible to purchase Carbon Financial Instruments reflecting mitigation elsewhere in the market if such standardized reduction objectives are not achieved. The opt-in electricity purchase provision is described further below with respect to FIG. 10.

The market can specify methods for monitoring emissions for a variety of sectors and activities. Members in the forest products sector that have wood harvesting operations can quantify and report net changes in carbon stocks (expressed in metric tons of CO₂ equivalent) held in above-ground biomass on land owned by the member or on land for which the member owns carbon sequestration rights. Exchange allowances (XAs) can be issued on an annual basis to these members in an amount reflecting net increases in stored carbon from the previous year. These allowances have the vintage of the year in which the increase in carbon storage occurred. These members surrender XAs, XOs or XEs on an annual basis in an amount reflecting net decreases in carbon stored in above-ground biomass.

Advantageously, the market participant base can be enlarged as additional entities seek to enroll. Expansion can be managed with a view to furthering the goals of the exchange and avoiding price congestion. New members can be bound to the same terms and obligations as original members. Use of a standardized, proportional emissions reduction schedule simplifies the addition of new members as the emission reduction objective of each existing members is not altered when new participants join the exchange. The capability of potential participants to join the exchange is continually changing as the strategic benefits of joining are better appreciated, and as the required skills base is expanded. Expansion of membership automatically causes an expansion of the trading opportunities for members and offset providers based on pre-set formulae.

In an exemplary embodiment, entities meeting the following conditions may become Associate Members: the entity does not have direct emissions; and the entity commits to the mitigation schedule or a mitigation objective that goes beyond the schedule. Associate Members can be subject to the same external audit of True-up that is conducted for Members. By allowing a broad range of entities to participate in the market, including entities that are not large industrial or energy concerns, the market encourages broader adoption of greenhouse gas reduction objectives, as well as the adoption of new and creative mitigation objectives (e.g. entities may wish to become carbon neutral for “indirect” emissions associated with company travel on commercial airlines).

FIG. 8 illustrates a flow diagram of an exemplary true-up process utilized in the system 10 described with reference to FIG. 1 and/or the system 100 described with reference to FIG. 3. The true-up process can involve the following operations, additional operations, or fewer operations depending on the embodiment. Members of the market apply facility and emissions monitoring rules to generate emissions data in an operation 810. The emissions data is communicated to the market and stored in an emissions database in an operation 820.

In accordance with true-up procedures, members are provided with annual notice of required instrument surrender quantities. Subsequent to each compliance year, each member must surrender any combination of exchange allowances, exchange offsets and exchange early action credits in an amount equal to CO₂ equivalent emissions released from that member's included facilities during the compliance year (subject to the economic growth provision described with respect to FIGS. 5 and 6 and constraints on the use of XOs and XEs). Compliance through the surrender of three different forms of Carbon Financial Instruments allows mitigation resources to flow to their highest-impact-per-dollar activity (e.g., emissions mitigation by members or by offset projects). It also makes operational the recognition and crediting of certain mitigation projects undertaken in advance of program launch.

Members provide notification of the instrument types and vintages to be retired in fulfillment of compliance commitment to the registry in the system in an operation 830. Data contained in the registry can be communicated to a retired Carbon Financial Instruments archive in an operation 840. As such, members “true-up” or account for allowances, offsets, and other emissions data. The market can also make adjustments in the allowed usage of offsets and early action credits based on the reported emissions data for all of the members.

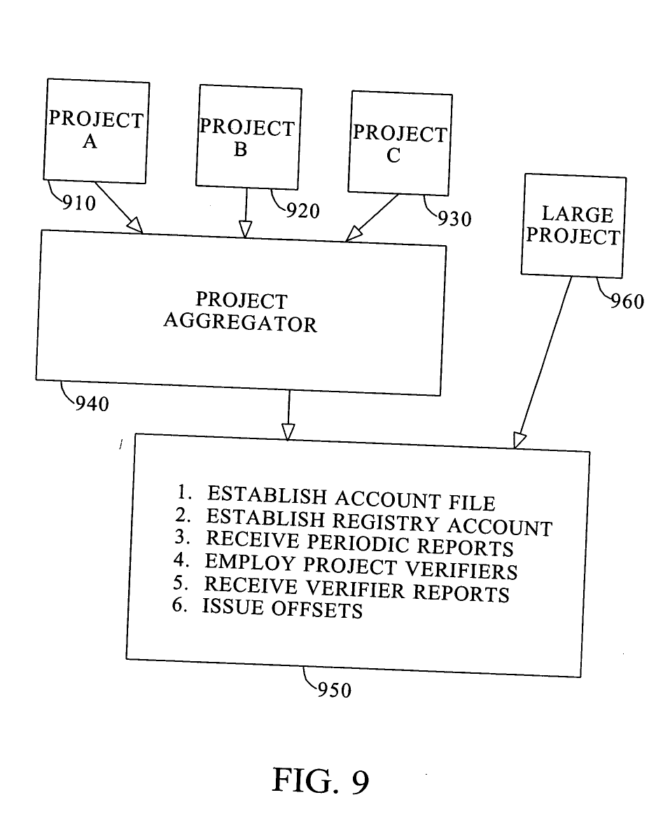

FIG. 9 illustrates offset project registration and reporting operations in the system 10 (FIG. 1) and/or the system 100 (FIG. 3). Additional, fewer, or different operations can be performed depending on the particular embodiment. In an exemplary embodiment, small projects 910, 920, and 930 have less than 10,000 metric tons of CO₂ per year. Small projects 910, 920, and 930 are combined in an aggregator operation 940.

Eligible projects can be recorded in the registry and are issued exchange offsets (XOs) on the basis of mitigation tonnage realized during a four year period. XOs can be issued after mitigation occurs and required documentation is presented to the market, or can be issued concurrently in anticipation of receipt of such documentation.

Some eligible offset project categories include landfill methane destruction in North America; agricultural methane destruction in North America; carbon sequestration in North America reforestation projects; carbon sequestration in U.S. agricultural soils; and fuel switching, landfill methane destruction, renewable energy and forestry projects in Brazil. For offset project types that have uncertain mitigation effectiveness, standardization of tradable offset quantities is achieved by applying discount factors so that members can have high confidence that a particular activity is defined so that each metric ton of CO₂ mitigated by each project is equivalent.

As shown in FIG. 9, a minimum amount of exchange offsets (XO) issuance to any project or group of projects in any single category can be set at 10,000 tons CO₂ equivalent per year (as an example). Individual projects that achieve mitigation quantities of less that 10,000 tons CO₂ equivalent per year are combined with other projects within the same project category by a market registered project aggregator. As such, trading can occur in quantities less than 10,000 tons.

The market can use the 10,000-ton threshold rule as a standard that establishes an offset pool scale allowing for economically efficient administration of the project enrollment, verification and offset issuance process. This provision allows low-cost mitigation actions to supply the market with reductions while also providing a source of funding for the implementation of such projects.

In the aggregator operation 940, the projects 910, 920, and 930 are examined to determine various features, such as, project eligibility based on type, location, and timing; whether contracts and/or attestations are properly executed; and estimated annual tonnage of offsets produced. Other examined features can include time commitments and property descriptions of sequestration projects, annual report acknowledgment, verifier access acknowledgment, entity name and facility, and management issues. The project-aggregation process of operation 940 allows multiple small projects to participate in the market without forcing the exchange or market participants to incur high administrative costs.

In an operation 950, the aggregation of small projects 910, 920, and 930 or a large project 970 are subject to a registration and reporting process. An exemplary registration and reporting process includes establishing an account file, establishing a registry account, receiving project reports, defining eligible project verifiers, receiving project verification reports from verifiers, receiving NASD reports on verifiers, and issuing offsets to accounts.

In another embodiment, carbon sequestration reserve pools are established to hold back a portion of earned offsets from project aggregators. These reserve pools provide a readily accessible pool of offsets that can be immediately cancelled if carbon stored in a credited sequestration project is later released to the atmosphere.

FIG. 10 illustrates a crediting mechanism for methane combustion. A methane (CH₄) source 1010 can be a landfill or agricultural waste, for example. Methane can have twenty-one times more environmental impact than CO₂. It is possible, however, to burn the methane using a combustion device 1015. The burning converts the methane to CO₂ while creating electric power from an electric power generator 1020. The burning of methane releases 2.75 tons of CO₂ for every one ton of methane. As such, the net equivalent emission reduction from burning methane is 18.25 metric tons of CO₂. Thus, an exchange landfill offset (XLO) can be issued in the market.

A market member 1030 can purchase electric power from the electric power generator 1020 as an emission reduction objective. The market member 1030 is selecting power in a way that returns “green power crediting” with the market. In an exemplary embodiment, landfill methane collection and combustion systems placed into operation can be issued exchange landfill offsets on the basis of tons of methane destroyed, net of CO₂ released upon combustion, during the years 2003 through 2006, for example. Benchmarks for methane reduction help remove uncertainty over which landfill gas projects can receive offsets, and at what rate and help ensure there is proper accounting so that electricity produced by combustion of landfill gas can be properly treated as CO₂ “neutral” (i.e., having no net GHG emissions associated with its production). As such, the benchmarks provide predictability and clarity in relation to determining if a landfill gas collection system qualifies to earn GHG offsets.

The use of the 18.25 metric ton net offset issuance rule (for each ton of methane combusted) accounts for the net-of-CO₂ GHG benefit from combusting landfill methane. This rule concomitantly establishes that electric power produced by combustion of landfill gas is CO₂-neutral as the CO₂ released upon combustion is netted-out in the offset issuance calculation. This characteristic thus establishes a complete and accurate accounting process that allows such purchased electricity to be considered “zero emissions.”

The market allows electricity users to elect to include electricity purchases as a supplemental reduction commitment. If a market member that elects this option reduces it electricity purchases to a level that is below its targeted reduction, the member is issued 0.61 tradable emission allowances for each megawatt-hour by which the member's actual electricity purchases fall below the reduction target. Simultaneously, the generator of such electricity also realizes an emission reduction (all else constant) as a result of reduced electricity demand on the part of the member. This reduction in emissions at the electric power plant can have the effect of freeing-up an emission allowance for sale. As such, this feature introduces the possibility that a single ton of actual emission reductions may result in the release into the market system of two tons worth of rights to emit CO₂, and the ownership of such rights is equally shared between the electricity user and the electricity generator. This pre-established equal sharing provides a standard formula that eliminates the need to negotiate the sharing of emission reduction rights associated with reduced electricity consumption.

The opt-in electricity purchase provision establishes a mechanism that employs standardized reduction schedule for end-use of electricity as a supplemental mitigation objective that can be elected by members. This provision also establishes a known, predictable quantity by which excess (or insufficient) electric power reductions are issued (or must surrender) greenhouse gas emission allowances. This predictability facilitates participation in this mitigation option and may stimulate adoption of electricity reduction technologies as the financial returns to such technologies are enhanced by the ability to earn marketable greenhouse gas emission allowances in the market.

The baseline electricity purchase quantity can be defined as the average of electricity purchases during previous years, such as 1998 through 2001. The baseline can be adjusted to reflect acquisition or disposition of facilities that consumed power purchased by the member. The definition of the electricity purchase baseline also contains rules governing inclusion of facilities; specifications for defining emissions “ownership” at jointly-owned facilities; and rules for addressing gaps in the baseline period electricity purchase data.

In an exemplary embodiment, members that opt-in U.S. electricity purchases and reduce their electricity purchases to levels below the quantity corresponding to the market reduction schedule are issued greenhouse gas emission allowances at a rate of 0.61 metric tons CO₂ for each megawatt-hour by which actual power purchased is below the reduction schedule. The 0.61 metric ton rate is applied only to electricity purchased by U.S. facilities as it reflects the U.S. average emission rate for electricity production during 1998-2001. Preferably, that opt-in electricity purchases and realize electricity purchases in an amount that is above the quantity corresponding to the market reduction schedule surrender greenhouse gas emission allowances and/or exchange offsets at a rate of 0.61 metric tons CO₂ for each megawatt-hour by which actual power purchased is above the reduction schedule. The corresponding standard values for electricity purchases in Canada and Mexico are 0.20 and 0.59 metric tons per megawatt-hour, respectively.

By setting a single, stable value of the crediting reductions in GHG emissions associated with each megawatt-hour of purchased electricity, the market provides a standardized reference value that makes it comparatively simple for large numbers of electricity users to participate in GHG mitigation and be rewarded at a known, predictable rate. The members who elect this option know in advance precisely how many tons of CO₂ emission allowances they receive (or must surrender) if they can surpass (or fail to achieve) the standardized reduction schedule.

This standardized, predictable system enhances the ability to test the electricity reduction commitment mechanism. By doing this, the provision allows a much broader range of entities to participate in GHG mitigation, even if they do not directly release significant amounts of GHGs through their own combustion of fuels or industrial processes. This mechanism provides a standard system whereby large commercial buildings (e.g., office buildings, shopping malls, government buildings, electricity-intensive manufacturing operations, and, conceivably, groups of small commercial utilities and households), can participate in a GHG reduction and trading program.

Another exemplary embodiment includes a method for integrating renewable energy certificates (RECs) markets into a greenhouse gas emissions trading market. The RECs markets are emerging in various states, provinces and countries as a means for cost-effectively increasing the quantity of electric power produced through environmentally preferable methods. Laws in multiple states (e.g., Texas and Nevada) require increasing amounts of electricity to be generated using low or zero-emission systems, such as wind energy. The RECs laws typically set a quantified overall objective (e.g. 5% of all electricity production for the year 2003) for renewable energy production and allows those who produce electricity from renewable energy systems in an amount above the mandated level to earn tradable certificates indicating they have exceeded the regulatory goal. If another electricity producer cannot achieve the legislated objective it can remain in compliance with the legislated mandate by acquiring RECs from the electricity producer that exceeded the legislated mandate. For example, the legislative mandate could require Company A and Company B to each to produce 1,000 megawatt-hours of electricity using specified renewable energy systems. If Company A in fact produces 1,200 megawatt-hours of electricity using renewable systems, it would earn 200 megawatt-hours worth of RECs. If Company B produces 800 megawatt-hours of electricity using renewable systems, it must acquire 200 megawatt-hours worth of RECs to achieve compliance with the legislative mandate (by producing 800 mw of renewable energy on its own and by acquiring 200 mw worth of RECs to demonstrate ownership of the other 200 mw of renewable energy production).

The market can allow its members to include electricity purchases as a supplemental reduction objective. For example, the market rules can provide the following: “Electricity produced using specified renewable energy sources can be treated as zero emission electricity by a Member that elects to opt-in electricity purchases. Each Member that elects to opt-in electricity purchases may exclude from its Electricity Purchases Baseline and Periodic Electricity Purchase Reports electricity acquired from market-specified Renewable Electricity Production Systems, provided the Member provides documentary evidence that the electricity is produced solely for the Member or is otherwise dedicated to the Member. Electricity produced by the following Renewable Electricity Production Systems shall qualify under this provision: solar; hydropower; wind; renewable fuels, which, for purposes of market are: wood, wood wastes and wood-derived fuels; agricultural residues and grasses; landfill and agricultural methane; and ethanol (bioalcohol). Documentary evidence that electricity is produced solely for the Member or is otherwise dedicated to the Member can consist of copies of power plant ownership documents, power purchase contracts, and, as specified by the Market Executive Committee, certain renewable energy certificates.”

By allowing members to use renewable energy certificates as a means of documenting that a portion of their electricity purchases are acquired from renewable energy systems, the market explicitly introduces a linkage between the greenhouse gas and RECs markets. This introduces an additional source of flexibility to members to achieve the electricity purchase reduction commitments via a systemic increase in production of electricity by renewable energy systems as evidenced by the Member's acquisition and presentation to the market of RECs. Incorporating this mechanism into the market architecture also provides another potential source of financing for new electricity production systems based on renewable energy sources.

Consistent with the economic growth provision described with reference to FIGS. 5 and 6, the maximum recognized increase in purchased power is, for example, 2% above baseline in 2003 and 2004, and 3% above baseline in 2005 and 2006. Without the economic growth provision limiting maximum required purchases, the maximum liability associated with participation in the market would be unknown. This mechanism allows potential participants to know, in advance with certainty, the maximum quantity of allowances they may have to purchase to achieve compliance with the annual electricity purchase reduction commitments, as well as the maximum quantity of sales of emission allowances they may be able to undertake.

Uncertainty as to how and how much to credit reduction in electric power purchases impedes adoption of reduction objectives and the end-use efficiency technologies and management methods that can contribute to mitigation of GHG emissions. By adopting standard greenhouse gas emission allowance quantities for reductions in electricity purchases in the U.S., Canada and Mexico, the market encourages participation in this mechanism and broadens the base of entities that can contribute to GHG mitigation via reductions in electricity purchases.

Members are responsible for emissions from jointly owned facilities in proportion to the member's ownership equity share, subject to the following exceptions. Members not primarily engaged in electric power production have the option to exclude from their emissions baseline and emission reports emissions from facilities in which the member's equity ownership share is less than 20%. Exceptions can be made on a case-by-case basis if a member's ownership share is less than 50% and emissions data from the jointly owned facility is not accessible to the member.

Entities primarily engaged in electric power production have the option to exclude from their emissions baseline and emission reports emissions from facilities in which the member's equity ownership share is both less than 20% and represents less than 25 megawatts of generating capacity.

Many large industrial and energy facilities are owned by multiple entities. These multiple owners often jointly invest in a facility as a means of spreading financial risk or exploiting the special business capabilities or locational advantage provided by one of the joint owners. The specific provisions for apportioning GHG emissions in the market for jointly owned facilities takes into consideration: the logic of employing a pro rata ownership approach; the desire to include a large proportion of each firms emissions, the importance of including major emission sources as a primary objective; the reality that minority owners of a facility may not have ready access to operational data needed to calculate emissions of a facility.

At the same time, by implicitly allowing a member to opt-in emissions from facilities in which it owns a relatively small equity share, these provisions encourage members to examine the possibility that such facilities may offer low-cost emission reductions. This flexibility encourages members to identify such low cost GHG reduction options, realize them and bring them into the market, which would enhance the overall cost effectiveness of the GHG emission reductions achieved through the market.

Each exchange member can be allowed annually to exempt a quantity of emissions that is equivalent to the emissions of a 500 megawatt capacity natural gas combined cycle electricity generating plant operated at 55% of capacity and having a heat rate of 7,000 btu/mwh. The exempt emissions cannot exceed emissions from the new facility or facilities. All new unit emissions above this level are included as part of the member's annual emissions. As such, members who build new facilities are not penalized in light of the fact that new facilities are typically more efficient (i.e. emit less GHG per unit of electricity produced) than existing facilities.

This provision reflects both an environmental rationale and a practical equity consideration. Development of new, higher-efficiency production facilities offers a means of fulfilling demand for products while producing less GHG emissions per unit of production. In addition, members may have been constructing such plants prior to the initiation of the market design phase. This provision establishes a limited exemption for emissions from new facilities, thereby removing or reducing the penalty that might have been in place if emissions from such facilities were required to be mitigated under the market rules.

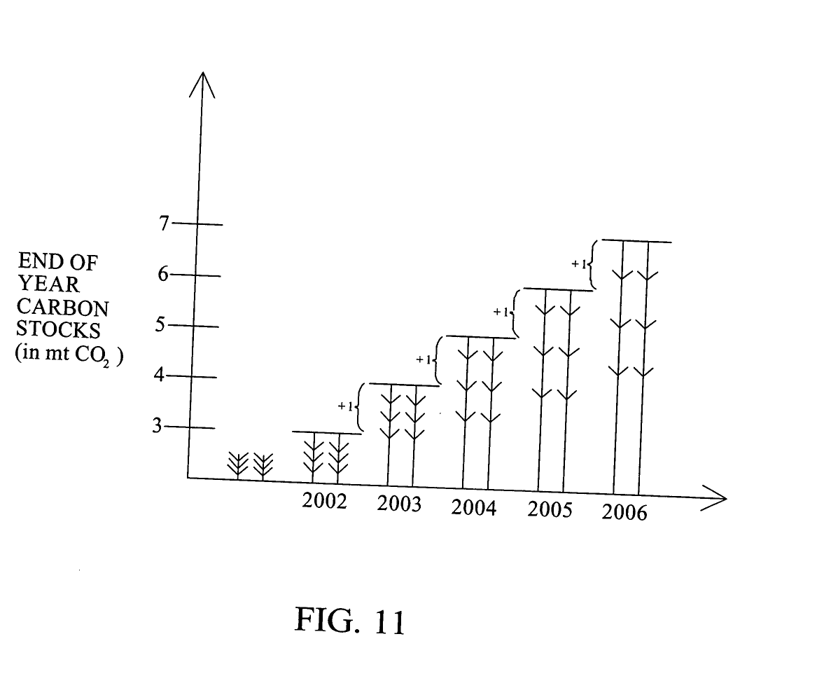

FIG. 11 illustrates a graph depicting exchange forestry offsets (XFOs) based on carbon storage. Similar to methane combustion projects, qualifying reforestation and afforestation projects can be issued Exchange Forestry Offsets on the basis of increases in tons of CO₂ equivalent of carbon storage realized. Project eligibility, project baselines, quantification, monitoring and verification protocols can be specified using the market. In the graph, XFOs of +1 are earned each year as end of year carbon stocks increase.

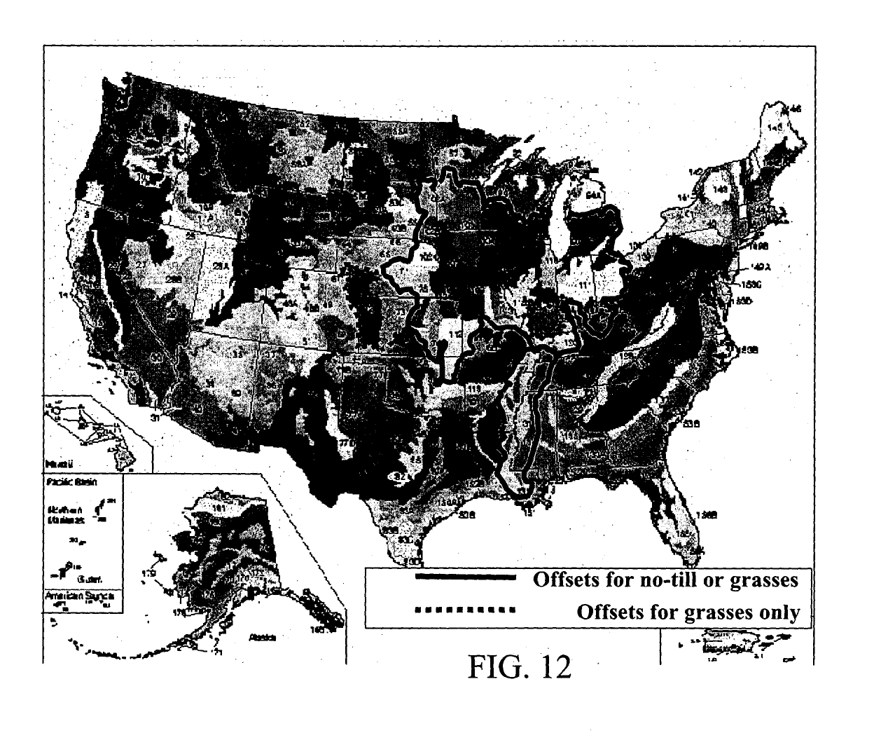

FIG. 12 illustrates a map of agricultural soil offsets based on geographic region. Offset issuance quantities for agricultural soil can standardize participation of GHG emissions mitigation via soil carbon sequestration. Soil carbon sequestration is realized when farmers or other individuals do not significantly disturb the soil surface through tillage and release carbon accumulated therein. In an exemplary embodiment, certified soil offsets can be issued annually for agricultural soil carbon sequestration activities in designated states, counties and parishes in the U.S. Midwest and Mississippi Delta regions. As an example, Exchange Soil Offsets can be issued at a rate of 0.5 metric tons CO₂ per acre per year in cases where farmers commit to qualifying continuous no-till or low-till in the designated locations. Exchange Soil Offsets can be issued at a rate of 0.75 metric tons CO₂ per acre per year in cases where farmers commit to maintain sequestration associated with grass plantings in the designated locations.

The market allows for the cost-effective incorporation of carbon sequestration by a large number of agricultural producers despite uncertain site-specific sequestration rates and high costs of measuring soil carbon changes.

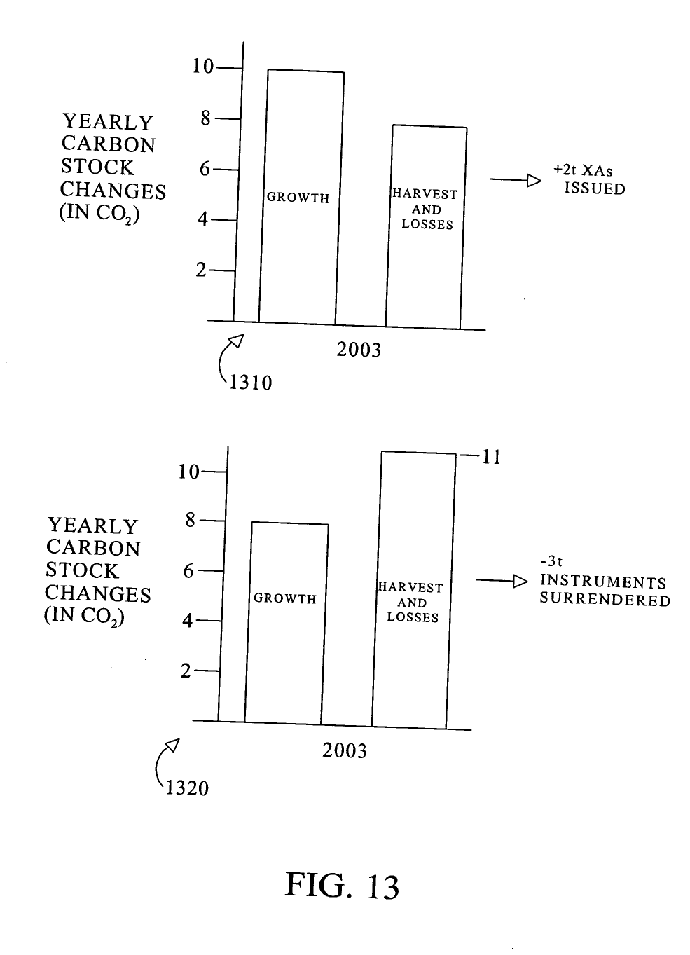

FIG. 13 illustrates the issuance of greenhouse gas emission allowances upon increases in qualifying carbon stocks by members of the market in the forest products sector. A graph 1310 depicts yearly carbon stock changes. The graph 1310 shows growth of carbon stock in 2003 as 10 metric tons CO₂ and harvest and other losses as 8 metric tons CO₂. As such, there is a +2 ton net change and XAs are issued to the member.

A graph 1320 shows growth of carbon stock in a particular year to be 8 metric tons CO₂ and harvest and other losses as 11 metric tons CO₂. In this case, the member is liable for a −3 net change and must surrender 3 tons of Carbon Financial Instruments.

Quantification of changes in carbon stocks held in above-ground biomass are based on standardized models and sampling procedures to be used by all members in the forest products sector. The calculation of changes in carbon stocks can be adjusted to reflect acquisition or disposition of forest land.

In an exemplary embodiment, the maximum amount of net reductions in carbon stored in above-ground biomass on company land recognized is limited to 3% of each member's emission baseline during a first year, such as 2003, 4% of its baseline during 2004, 6% of its baseline during 2005 and 7% of its baseline during 2006. The maximum recognized quantity of net increases in carbon stored in above-ground biomass is limited to 3% of the member's emission baseline during a first year, such as 2003, 4% of its baseline during 2004, 6% of its baseline during 2005 and 7% of its baseline during 2006. Net sales and banking of Exchange Allowances by members are also subject to limits described below.

Increased carbon sequestration associated with changes in carbon stocks due to forest management activities offer an important GHG mitigation option and should be recognized and credited (or debited if such changes cause a reduction in stored carbon). Preferably, greenhouse gas emission allowances are issued in an amount reflecting net increases in stored carbon during the 1-4 years time period. These members must surrender XAs, XOs or XEs on an annual basis in an amount reflecting net decreases in stored carbon during the four year time period. The calculation of changes in carbon stocks can be adjusted to reflect acquisition or disposition of forest land.

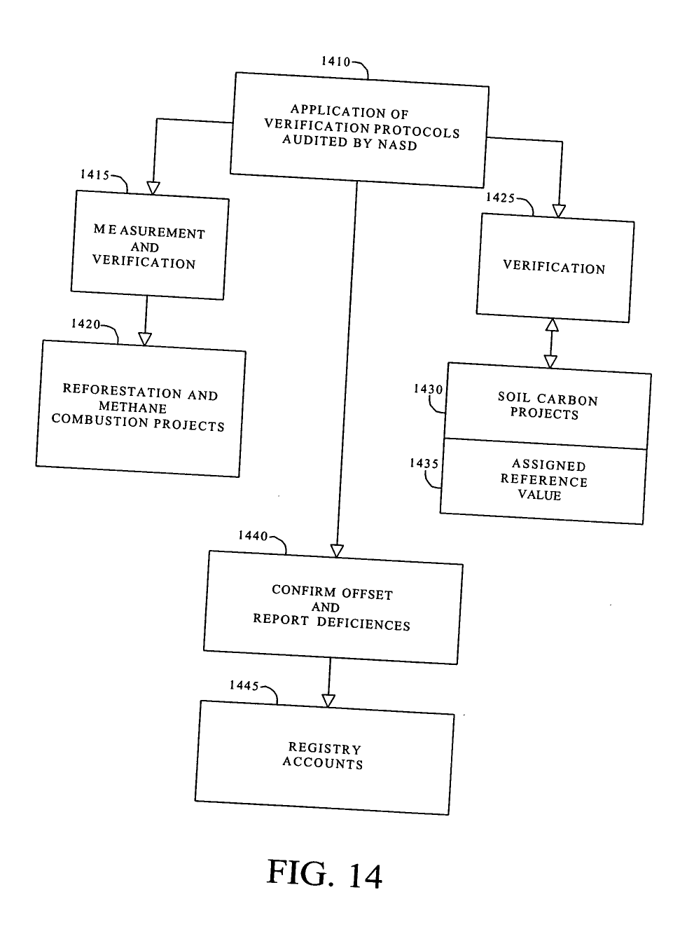

FIG. 14 illustrates an offset project verification process. Additional, fewer, or different operations can be performed in the process, depending on the particular embodiment. In an operation 1410, NASD audits can be performed using protocols. Independent measurement and verification can be performed in an operation 1415 on reforestration and methane combustion projects 1420.

In an operation 1425, independent verification is performed on soil carbon projects 1430 that contracted practices are undertaken. A reference value can be assigned in operation 1435. The offset project tonnage can be confirmed and deficiencies reported in an operation 1440. Confirmed offsets are communicated to registry accounts of individual projects and aggregators in an operation 1445.

The market can specify project eligibility, project baselines, quantification, monitoring and verification protocols. This feature helps to satisfy the need for a predictable, low transaction cost protocol that provides to farmers, in advance of their decision to commit to a contract to provide carbon sequestration services, precise information on the quantity of offsets they earn per acre per year for eligible soil carbon sequestration practices.

By way of another example, Exchange Emission Reductions can be issued to qualifying projects undertaken in Brazil or other countries. Qualifying projects include: reforestation and/or assisted forest regeneration; avoided deforestation together with reforestation and/or assisted forest regeneration; fuel switching; landfill methane destruction; and renewable energy generation from solar, wind, small hydroelectric and biomass systems.

Exchange Early Action Credits (XEs) can be issued to certain projects previously undertaken. To qualify, projects must be: off-system; originally undertaken or financed by members; direct emissions reductions or involve sequestration; clearly owned by the members; measured; and verifiable. By establishing specifications for this provision, it is possible to define which actions undertaken before activation of its GHG market are eligible to earn early action credits. This standard is of particular value as many legislative proposals worldwide that propose GHG limits have recognized the importance (in terms of equity and provision of incentives to act early) of including an early-action crediting provision.

By way of example, Exchange Early Action Credits can be given to the following project types that meet the eligibility criteria: reforestation, afforestation and avoided deforestation; landfill methane destruction in the U.S.; fuel switching and other energy related U.S.I.J.I. projects. Exchange Early Action Credits are issued on the basis of mitigation tonnage realized by the qualifying project.

Numerous legislative proposals in the U.S. and elsewhere have proposed the general concept of crediting “early action”. The rationale for this concept is to encourage early action to mitigate GHGs by removing an incentive to postpone action. It is sometimes argued that entities that could reduce GHG emissions in the near-term in fact refrain from doing so because they would lose the opportunity to be credited for such reductions if they are realized prior to enactment of legislation or other actions that cause the emergence of a GHG reduction and trading system. By establishing precedent that demonstrates that “early” action can be effectively credited in an organized GHG reduction and trading system, this provision may stimulate GHG mitigation actions that might otherwise be postponed or never undertaken.

A limited number of market constraints are employed in order to assure that emission mitigation under the market reflects a balance of emission reductions at member facilities and reductions from off-system projects, and to prevent market instability and price congestion. The market does not endorse the imposition of limits on trading or on the use of offsets in large scale GHG trading systems that may emerge a market created by government regulation.

Net sales of Exchange Allowances by any single member are limited to 0.5% of the program-wide emissions baseline, apportioned over 2003-2006 according to the schedule in Table 2 below.

TABLE 2

| | |
|---|---|
| | Net Exchange Allowance (XA) sales limit: percent |
| | of program-wide baseline |
| XA | emissions that can be sold by a single firm for |
| Vintage | each XA Vintage |

| | | |
|---|---|---|
| 2003 | | 0.05% |
| 2004 | | 0.10% |
| 2005 | | 0.15% |
| 2006 | | 0.20% |
| | Total | 0.50% |
| | | of program-wide |
| | | baseline emissions |

In an exemplary embodiment, the market can include ¢super reductions” which can be sold to non-members that may seek to purchase emission reductions that are registered in the context of a rules-based program. These “super reductions” reflect cases where members reduce emissions beyond the maximum reductions recognized as tradable, as per market rules. Additionally, “super reductions” may be usable in pilot markets that may be established subsequent to 2006.

By way of example, during a first year, program-wide use for compliance of Exchange Emission Offsets is allowed in an amount equal to 0.5% of the total program-wide baseline emissions. Exchange Early Action Credits may be used for compliance starting in a second year. During subsequent years after the first year, program-wide use of Exchange Emission Offsets plus Exchange Early Action Credits is allowed in an amount equal to 4.5% of the total program-wide baseline emissions. As such, limitations on the use of Exchange Offsets plus Early Action Credits are adjusted in a predictable manner, and in proportion to expansion of the market due to new entrants (and contraction due to disposition of emission sources by members).

Such a provision assures that the majority of GHG mitigation in the market occurs at member facilities, maintaining market balance, diversity and environmental credibility while allowing development and use of project-based offsets and implementing a method for crediting early action. By limiting the allowed use of Exchange Emission Offsets plus Exchange Early Action Credits, this provision establishes that at least half of the overall GHG mitigation realized by member must come from reductions in the emissions released by their own facilities.

By limiting the proportion of Carbon Financial Instruments produced by prior emission mitigation projects used in compliance in the market to no more than 25% of the program-wide emission reduction, the market effectively requires that 75% of the reductions come from mitigation actions that occur concurrently or in the future, (or occurred recently e.g. via mitigation projects occurring after a certain date). This provision also helps to maintain market balance and diversity of mitigation efforts.

The total program-wide quantity of Exchange Early Action Credits used for compliance during years subsequent to the first year preferably does not exceed 50% of the total quantity of Exchange Offsets plus Exchange Early Action Credits used for compliance. Total allowed use for compliance of Exchange Offsets during the first year, and Exchange Emission Offsets plus Exchange Early Action Credits during subsequent years are escalated if program-wide emissions rise above baseline levels. The proportional escalation mechanism reflects the extent to which program-wide emissions exceed program-wide baseline emission levels. Advantageously, this mechanism establishes a formulaic predictable process that automatically loosens market efficiency provisions as demand rises.

For each member, total net sales plus use for compliance of Exchange Offsets (e.g. Landfill Offsets) produced by facilities that it owns and/or operates are allowed in an amount equal to no more than 0.5% of the total program-wide baseline emissions, apportioned over certain years. By way of example, limits can be as indicated in Table 3.

TABLE 3

| | |
|---|---|
| | Total net sales plus use for |
| XO | compliance of XOs generated from member's |
| Vintage | owned and operated facilities, by XO vintage |

| | | |
|---|---|---|
| 2003 | | 0.05% |
| 2004 | | 0.10% |
| 2005 | | 0.15% |
| 2006 | | 0.20% |
| | Total | 0.5% |
| | | of program-wide |
| | | baseline emissions |

Such a feature avoids market imbalance, price congestion and potential for market dominance by a single seller of Exchange Offsets or a small group of sellers by constraining the quantity of sales any single firm can make. Certain individual members may be in a position to sell large quantities of Exchange Offsets. As is the case with any limited-scale and limited-coverage market, should any single member or small group of members be allowed to sell without limit, the market could become imbalanced and subject to price congestion. Similarly, unrestrained ability to sell could cause a single-firm to achieve a dominant status of the sell-side of the market, which would be damaging to market competition.

Allowed sales plus use for compliance by a single member under this provision can be escalated proportionately if program-wide emissions rise above baseline levels. The escalation mechanism reflects the extent to which program-wide emissions exceed program-wide emission baseline levels. Advantageously, this mechanism establishes a formulaic predictable process that automatically loosens market efficiency provisions as demand rises.

By way of summary, system 10 (FIG. 1) and/or system 100 (FIG. 3) (again, collectively referred to herein as “the market”) provide an electronic mechanism for hosting greenhouse gas commodity trading. It provides participants with a central location that facilitates trading, publicly reveals price information, and contributes to the broad objectives of the emission reduction plan. The market reduces the cost of locating trading counterparties and finalizing trades, an important benefit in a new market. The market may also be used as the platform for conducting the periodic auctions. The market could host trading in standardized contracts that, for example, provide a uniform trade size, pricing terms and payment requirements. The market may have the following core features: low cost to users; easy-to-use for participants, allow for real-time trading and price information, and readily interface with the registry accounts of participants in the commodity market.

The market overcomes many of the shortcomings and disadvantages of conventional emissions trading programs. For example, the absence of a complete, standardized system for defining and trading greenhouse gas reductions introduces high transaction costs and impedes the widespread initiation of action to reduce greenhouse gas emissions among private, non-profit and public sector entities. The market provides a method for greenhouse gas reduction through a commodity based trading program. Unlike ad hoc or unstandardized emissions trading programs, the market provides a commodity-based exchange that facilitates capital flows to environmental protection by employing a central electronic trading mechanism coupled with a means of guaranteeing receipt of payment and delivery of traded Carbon Financial Instruments even if a counter-party fails to perform.

Another shortcoming of conventional systems is how to facilitate participation in greenhouse gas reduction efforts by multiple sectors in multiple countries, thus advancing environmental progress and enhancing the prospects for cost effectiveness by allowing reductions to occur in a wide range of organizations.

The standardized emission reduction schedule applied in the capped trading system described herein establishes a common, proportionate system under which all exchange members know both their emission reduction objectives and the maximum liability they may face in meeting such objectives.

Another shortcoming of conventional systems is the lack of common rules, standards, protocols and methods which impedes large-scale participation in GHG mitigation efforts and limits the ability to realize mitigation at low cost. Preferably, the market includes a structured market design and standardized environmental objective that allows numerous participants to mitigate greenhouse gases on a common schedule. This reduces transaction costs and facilitates broader action and ease of transacting and introduces a mechanism for allowing efficient flow of financial resources to the mitigation of greenhouse gases.

Use of a standardized, proportional emissions reduction schedule simplifies addition of new members as the emission reduction objective of each existing member is not altered when new participants join the exchange. The capability of potential participants to join the exchange is continually changing as the strategic benefits of joining are better appreciated, and as the required skills base is expanded. Starting with a limited-scale pilot market allows for near-term demonstration of the exchange. In addition, the ability to test and refine methods and systems is enhanced by having limited scale.

Expansion of membership automatically causes an expansion of the trading opportunities for members and offset providers based on pre-set formulae, while also providing the mechanisms to maintain market balance.

Unlike any other existing emissions trading program, use of a “live,” electronic trading platform allows members and participants to continuously view bids, offers and transaction prices and volumes. Continuous price discovery enhances the ability of members to identify the least-cost methods for achieving compliance with the reduction commitments. Advantageously, public price discovery informs the development of private and legislative actions to mitigate greenhouse gases. Currently, there is no systematic method for making public prices from greenhouse gas emission reduction trades. Thus, the formation of private and legislative actions suffers from the absence of critical information needed to establish economically rational actions. Without price information, the ability to develop GHG reduction action plans is impeded because cost-benefit analysis is conducted with severely limited information on mitigation costs.

Lack of a common, rules based framework in conventional systems impedes economically efficient use of emission mitigation resources. The market embodied in the system 10 and/or the system 100 allows flexibility in the methods, location and timing of emission reductions so that greenhouse gas emissions can be reduced cost effectively.

With conventional systems, the action to cut and trade greenhouse gases is greatly impeded by high transaction costs. System 10 and/or system 100 facilitates trading with low transaction costs. A rules-based program, a central trading platform, delivery and payment guarantees and low transaction costs implemented in system 10 and/or system 100 greatly reduce the impediments to trading, thus allowing all market participants to exploit the opportunity to realize economic gains from trading. Such features help assure that greenhouse gas emission reductions are both undertaken more broadly and are realized at the lowest possible cost.

This detailed description outlines exemplary embodiments of an emissions reduction and trading system and method. In the foregoing description, for purposes of explanation, numerous specific details are set forth in order to provide a thorough understanding of the present invention. It is evident, however, to one skilled in the art that the exemplary embodiments may be practiced without these specific details. In other instances, structures and devices are shown in block diagram form in order to facilitate description of the exemplary embodiments.

Systems can be included within the market for performing a variety of functions. For example, a system can be included to designate individual employees of market members, associate members, and participant members as authorized traders of such members. Another system can be included to screen all entities that desire to become market members, associate members, and participant members on the basis of financial standing and business stability. Yet another system allows traders to elect to utilize market provided trade negotiation and clearing mechanisms or, alternatively, to negotiate trades in a private, bilateral fashion.

Advantageously, the systems and methods described here enable the creation and operation of a greenhouse gas emissions market with reduced transaction costs. The minimization of transactions costs may be a result of one or more of a variety of different factors. These factors include the standardizing of definitions of included emissions and opt-in provisions; allocating ownership of emissions in cases of jointly owned facilities; defining emission baselines; defining tradable Carbon Financial Instruments; defining Early Action Credits; emissions monitoring methods;-offset project definitions (including formulae) and sizes and aggregation; market constraints; the registry; the trading platform; and the clearing system.

In some embodiments, a computer system is used for the implementation of these systems and markets which has a central processing unit (CPU) that executes sequences of instructions contained in a memory. More specifically, execution of the sequences of instructions causes the CPU to perform steps, which are described below. The instructions may be loaded into a random access memory (RAM) for execution by the CPU from a read-only memory (ROM), a mass storage device, or some other persistent storage. In other embodiments, hardwired circuitry may be used in place of, or in combination with, software instructions to implement the functions described. Thus, the embodiments described herein are not limited to any specific combination of hardware circuitry and software, nor to any particular source for the instructions executed by the computer system.

While the exemplary embodiments illustrated in the figures and described above are presently preferred, it should be understood that these embodiments are offered by way of example only. Other embodiments may include, for example, different additional, or fewer market rules to facilitate the operation and acceptance of the GHG trading market. The invention is not limited to a particular embodiment, but extends to various modifications, combinations, and permutations that nevertheless fall within the scope and spirit of the appended claims.

What is claimed is:

1. An emissions reduction trading system comprising:
a registry that stores emission allowance and offset holding information for participants in a greenhouse gas emissions market; and
a trading platform communicatively coupled to the registry, the trading platform being configured to enable trades of emission allowances and offsets by participants.

2. The system of claim 1, further comprising a guarantee mechanism that ensures next-day payment for exchange-cleared trades transacted using the trading platform despite failure of buyer to execute payment.

3. The system of claim 1, wherein the trading platform can perform auctions of exchange allowances and/or offsets.

4. The system of claim 3, wherein the auctions comprise single-clearing price auctions or discriminating price auctions.

5. The system of claim 1, wherein the greenhouse gas emissions market comprises multi-sector and multi-national components.

6. The system of claim 1, wherein participants register projects that are issued offsets amounting to at least a minimum level of mitigated tons of CO₂ per year.

7. The system of claim 6, wherein participants not having projects with offsets amounting to at least the minimum level of offset issuance per year are aggregated into groups having collective projects with collective offsets totaling at least the minimum level of issued tons of CO₂ per year.

8. The system of claim 1, wherein the trading platform communicates with the registry to confirm identities of participants buying and selling trades while providing anonymous trading to the participants.

9. The system of claim 1, wherein the emission allowance and offset holding information stored by the registry includes baseline information.

10. The system of claim 9, wherein the registry further includes reduction schedule, economic growth provision limitations, and mitigation quantity information.

11. The system of claim 1, wherein the trading platform manages a standardized greenhouse gas emissions trading program among a number of business sectors.

12. The system of claim 1, wherein the trades of emission allowances and offsets by participants are done in real-time.

13. A method of conducting trades among participants in an emissions reduction and trading system over a communication network, the method comprising:
establishing baselines for participants in an emissions trading market and reduction levels from the baselines;
obtaining emissions information from the participants, the emissions information including emissions allowance and offset information;
determining on an individual participant basis required purchases and allowed sales; and
managing trades among participants to meet the determined required purchases and allowed sales.

14. The method of claim 13, wherein the baselines for participants are established from an average of emission levels in previous years.

15. The method of claim 13, wherein the reduction levels are a predetermined percentage decrease from each preceding year.

16. The method of claim 13, wherein individual participants are permitted sales of allowances up to the number of allowed sales determined.

17. The method of claim 13, wherein the required purchases for individual participants are capped at a predetermined percentage above the baseline for the individual participant.

18. The method of claim 13, wherein the managing trades among participants comprises transacting trades using a guarantee mechanism to ensure payment after trades are completed.

19. The method of claim 13, wherein the managing trades among participants comprises transacting trades using a reserve pool to ensure delivery of purchased Carbon Financial Instruments despite failure of seller to execute delivery.

20. A system for conducting trades among participants in an emissions reduction and trading system over a communication network, the system comprising:
means for establishing baselines for participants in an emissions trading market and reduction levels from the baselines;
means for obtaining emissions information from the participants, the emissions information including emissions allowance and offset information;
means for determining on an individual participant basis required purchases and allowed sales; and
means for managing trades among participants to meet the determined required purchases and allowed sales.

21. The system of claim 20, wherein individual participants are permitted sales of allowances up to the number of allowed sales determined.

22. The system of claim 20, wherein the required purchases for individual participants are capped at a predetermined percentage above the baseline for the individual participant.

23. The system of claim 20, wherein means for managing trades among participants comprises means for transacting trades to ensure payment after trades are completed.

24. The system of claim 20, wherein means for managing trades among participants comprises means for transacting trades to ensure payment despite failure of buyer to promptly make payment.

25. A method of employing standards in the creation, maintenance, and operation of a greenhouse gas emissions trading market, the method comprising:
establishing and operating a greenhouse gas emissions trading market using standards for:
trading Carbon Financial Instruments, the trading Carbon Financial Instruments including any one of allowances, offsets, and early action credits;
emissions reductions, the emissions reductions including baseline emission information and types of included facilities;
eligible offset projects;
constraints on trading, the constraints including single-firm sales limits;
an annual true-up procedure;
emissions and project quantification methods; and
maximum required purchases and maximum allowed sales.

26. The method of claim 25, wherein the emissions reductions further comprise an emissions mitigation schedule and emission monitoring protocols that vary by sector.

27. The method of claim 25, wherein the eligible offset projects comprise any one of landfill offsets, agricultural methane offsets, forestry offsets, soil offsets, and certified emissions reductions.

28. The method of claim 25, wherein the mitigation programs comprise electricity purchases from electricity production where emissions are mitigated.

29. The method of claim 25, further comprising establishing and operating the greenhouse gas emissions trading market using standards for auditing processes.

30. In an emissions reduction and trading system, a method including an electricity opt-in program, the method comprising:
establishing an electricity purchase baseline for a market participant;
receiving information on electricity purchases for the market participant;
determining qualification for allowance credit or debit based on the received information on electricity purchases for the market participant; and
transacting the allowance surplus or shortfall as determined.

31. The method of claim 30, further comprising fixing a division of rights to reductions in emissions from electric power generators that result from reduced electricity demand on the part of a market member that exceeds an electricity purchase reduction objective, wherein the division is an equal sharing between the electricity producer and the electricity buyer.

32. An emissions reduction and trading system including an electricity opt-in program, the system comprising:
means for establishing an electricity purchase baseline for a market participant;
means for receiving information on electricity purchases for the market participant;
means for determining qualification for allowance credit or debit based on the received information on electricity purchases for the market participant; and
means for transacting the allowance credit or debit as determined.

33. An electronic auction configured to be conducted over a network of computers or conducted manually, the auction being for the purchase and selling of greenhouse gas allowances in an emissions reduction and trading system, the auction comprising:
an auction pool of greenhouse gas allowances received from an auction reserve or allowance offers;
bids for greenhouse gas allowances in the auction pool, the bids being received electronically via a network or manually; and
a processor to determine winning bids based on pre-determined parameters, the processor being configured to communicate auction results to member accounts in a registry for transfer of allowances, the processor being further configured to return proceeds pro rata to participants based on contributions of the participants to the auction reserve.

34. The auction of claim 33, wherein the auction is held annually or periodically during each year.

35. The auction of claim 33, wherein the processor determines price for the winning bids based on a single-clearing price process.

36. The auction of claim 33, wherein the processor determines price for the winning bids based on a discriminating price process.
